(19) United States
(12) Patent Application Publication
(10) Pub. No.: US 2018/0032712 A1
(43) Pub. Date: Feb. 1, 2018

(54) ELECTRONIC DEVICE AND METHOD FOR AUTHENTICATING BIOMETRIC INFORMATION

(71) Applicant: SAMSUNG ELECTRONICS CO., LTD., Suwon-si (KR)

(72) Inventors: Seung Won OH, Suwon-si (KR); In Ho KIM, Suwon-si (KR); Yong Wan LEE, Seoul (KR); Yong Seok PARK, Yongin-si (KR)

(21) Appl. No.: 15/660,033

(22) Filed: Jul. 26, 2017

(30) Foreign Application Priority Data
Jul. 29, 2016 (KR) 10-2016-0097367

(51) Int. Cl. G06F 21/32; H04L 9/08; G06Q 20/40

(52) U.S. Cl. CPC G06F 21/32; G06Q 20/40145; H04L 9/0866

(57) ABSTRACT

An electronic device includes a plurality of biometric sensors that each sense pieces of biometric information of different types, respectively, a communication circuit that communicates with an authentication server, a memory that stores a payment application, and a processor electrically connected with the plurality of biometric sensors, the communication circuit, and the memory. The processor is configured to generate pieces of account information respectively corresponding to the plurality of biometric sensors, to make a request for authentication of the biometric information corresponding to the account information to the authentication server using account information, which corresponds to biometric information to be authenticated, from among the pieces of account information, is the payment application is executed, and to receive a response to the request for the authentication from the authentication server.

### CROSS-REFERENCE TO RELATED APPLICATION

This application is based on and claims priority under 35 U.S.C. § 119 to a Korean patent application filed on Jul. 29, 2016 in the Korean Intellectual Property Office and assigned Serial number 10-2016-0097367, the disclosure of which is incorporated by reference herein in its entirety.

### TECHNICAL FIELD

The present disclosure relates generally to an authentication technology using biometric information.

### BACKGROUND

As an information technology (IT) develops, an electronic device has significantly superior functions and provides a user with various functions. The electronic device provides a user with a network-based communication service such as a multimedia service, a call service, a wireless Internet service, a short message service (SMS), a multimedia messaging service (MMS), or the like.

The electronic device makes use of a biometric sensor sensing biometric information, such as a fingerprint, a face, an iris, and/or a vein, to authenticate a user. For example, the electronic device performs fast identity online (FIDO) authentication using the biometric information.

In the case where the electronic device senses various pieces of biometric information using a plurality of biometric sensors (e.g., a fingerprint sensor, an iris sensor, and a vein sensor), the procedure of authenticating the biometric information may be complicated. For example, when performing the FIDO authentication, the electronic device needs to perform different authentication procedures depending on types of the biometric information to be authenticated or whether a biometric sensor is registered. Accordingly, the procedure of authenticating the biometric information may be more complex and may involve an unnecessary operation.

### SUMMARY

Various example aspects of the present disclosure address at least the above-mentioned problems and/or disadvantages and to provide at least the advantages described below. Accordingly, an example aspect of the present disclosure is to provide an electronic device capable of performing authentication of various types of biometric information simply.

In accordance with an example aspect of the present disclosure, an electronic device includes a plurality of biometric sensors that sense pieces of biometric information of different types, respectively, a communication circuit that is configured to communicate with an authentication server, a memory that stores a payment application, and a processor electrically connected with the plurality of biometric sensors, the communication circuit, and the memory. The processor is configured to generate pieces of account information respectively corresponding to the plurality of biometric sensors, if the payment application is executed, using account information, corresponding to biometric information to be authenticated, from among the pieces of account information, to make a request for authentication of the biometric information corresponding to the account information to the authentication server, and to receive a response to the request for the authentication from the authentication server.

In accordance with an example aspect of the present disclosure, a biometric information authenticating method of an electronic device including a plurality of biometric sensors includes generating pieces of account information respectively corresponding to the plurality of biometric sensors, if a payment application is executed, using account information, which corresponds to biometric information to be authenticated, from among the pieces of account information, making a request for authentication of the biometric information corresponding to the account information to the authentication server, and receiving a response to the request for the authentication from the authentication server.

In accordance with an example aspect of the present disclosure, a computer-readable recording medium having recorded thereon an instruction, when executed by at least one processor, causes the processor to generate pieces of account information respectively corresponding to a plurality of biometric sensors, if a payment application is executed, using account information, which corresponds to biometric information to be authenticated, from among the pieces of account information, to make a request for authentication of the biometric information corresponding to the account information to the authentication server, and to receive a response to the request for the authentication from the authentication server.

In accordance with an example aspect of the present disclosure, an electronic device includes a housing, a touch screen display exposed through a part of the housing, a first biometric information sensor disposed in a part of the housing, a second biometric information sensor disposed in another part of the housing, a wireless communication circuit disposed in the housing, a processor electrically connected with the touch screen display, the first biometric information sensor, the second biometric information sensor, and the wireless communication circuit, and a memory electrically connected with the processor. The memory stores first FIDO account information associated with the first biometric information sensor and second FIDO account information associated with the second biometric information sensor. The memory stores instructions, when executed, that cause the processor to execute at least one application program, to perform user authentication, while executing the application program, using at least one of the first biometric information sensor or the second biometric information sensor, to receive biometric information of a user using one of the first biometric information sensor or the second biometric information sensor to perform user authentication, to encrypt the result of the user authentication using a private key associated with FIDO account information corresponding to one biometric information sensor to be used, and to transmit the result of the encrypted authentication to the outside using the wireless communication circuit.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and attendant advantages of the present disclosure will be more apparent and readily appreciated from the following detailed description, taken in conjunction with the accompanying drawings, in which like reference numerals refer to like elements, and wherein:

FIG. 1 is a diagram illustrating an example electronic device in a network environment, according to various example embodiments;

FIG. 2 is a block diagram illustrating an example electronic device, according to various example embodiments;

FIG. 3 is a block diagram illustrating an example program module, according to various example embodiments;

FIG. 4 is a diagram illustrating an example operating environment of an electronic device, according to an example embodiment;

FIG. 5 is a block diagram illustrating an example configuration of the electronic device, according to an example embodiment;

FIG. 6 is a diagram illustrating example account information generated by an electronic device, according to an example embodiment;

FIG. 7 is a flowchart illustrating an example biometric information authenticating method of an electronic device, according to an example embodiment;

FIG. 8 is a flowchart illustrating an example biometric information authenticating method of an electronic device, according to an example embodiment;

FIG. 9 is a flowchart illustrating an example biometric information authenticating method of an electronic device, according to an example embodiment;

FIG. 10 is a flowchart illustrating an example biometric information authenticating method of an electronic device, according to an example embodiment; and

FIG. 11 is a flowchart illustrating an example biometric information authenticating method of an electronic device, according to an example embodiment.

Throughout the drawings, it should be noted that like reference numbers are used to depict the same or similar elements, features, and structures.

### DETAILED DESCRIPTION

Hereinafter, various example embodiments of the present disclosure may be described with reference to accompanying drawings. Accordingly, those of ordinary skill in the art will recognize that modification, equivalent, and/or alternative on the various embodiments described herein can be variously made without departing from the scope and spirit of the present disclosure. With regard to description of drawings, similar elements may be marked by similar reference numerals.

In this disclosure, the expressions “have”, “may have”, “include” and “comprise”, or “may include” and “may comprise” used herein indicate existence of corresponding features (e.g., elements such as numeric values, functions, operations, or components) but do not exclude presence of additional features.

In this disclosure, the expressions “A or B”, “at least one of A or/and B”, or “one or more of A or/and B”, and the like may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used in this disclosure may be used to refer to various elements regardless of the order and/or the priority and to distinguish the relevant elements from other elements, but do not limit the elements. For example, “a first user device” and “a second user device” indicate different user devices regardless of the order or priority. For example, without departing the scope of the present disclosure, a first element may be referred to as a second element, and similarly, a second element may be referred to as a first element.

It will be understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. On the other hand, when an element (e.g., a first element) is referred to as being “directly coupled with/to” or “directly connected to” another element (e.g., a second element), it should be understood that there are no intervening element (e.g., a third element).

According to the situation, the expression “configured to” used in this disclosure may be used as, for example, the expression “suitable for”, “having the capacity to”, “designed to”, “adapted to”, “made to”, or “capable of”. The term “configured to” must not refer only to “specifically designed to” in hardware. Instead, the expression “a device configured to” may refer to a situation in which the device is “capable of” operating together with another device or other components. For example, a “processor configured to (or set to) perform A, B, and C” may refer, for example, to a dedicated processor (e.g., an embedded processor) for performing a corresponding operation or a generic-purpose processor (e.g., a central processing unit (CPU) or an application processor) which performs corresponding operations by executing one or more software programs which are stored in a memory device.

Terms used in this disclosure are used to describe specified embodiments and are not intended to limit the scope of the present disclosure. The terms of a singular form may include plural forms unless otherwise specified. All the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal unless expressly so defined in various embodiments of this disclosure. In some cases, even if terms are terms which are defined in this disclosure, they may not be interpreted to exclude embodiments of this disclosure.

An electronic device according to various embodiments of this disclosure may include at least one of, for example, smartphones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, or wearable devices or the like, but is not limited thereto. According to various embodiments, the wearable device may include at least one of an accessory type (e.g., watches, rings, bracelets, anklets, necklaces, glasses, contact lens, or head-mounted-devices (HMDs), a fabric or garment-integrated type (e.g., an electronic apparel), a body-attached type (e.g., a skin pad or tattoos), or a bio-implantable type (e.g., an implantable circuit) or the like, but is not limited thereto.

According to various embodiments, the electronic device may be a home appliance. The home appliances may include at least one of, for example, televisions (TVs), digital versatile disc (DVD) players, audios, refrigerators, air conditioners, cleaners, ovens, microwave ovens, washing machines, air cleaners, set-top boxes, home automation control panels, security control panels, TV boxes (e.g., Samsung HomeSync™, Apple TV™, or Google TV™), game consoles (e.g., Xbox™ or PlayStation™), electronic dictionaries, electronic keys, camcorders, electronic picture frames, or the like, but is not limited thereto.

According to another embodiment, an electronic device may include at least one of various medical devices (e.g., various portable medical measurement devices (e.g., a blood glucose monitoring device, a heartbeat measuring device, a blood pressure measuring device, a body temperature measuring device, and the like), a magnetic resonance angiography (MRA), a magnetic resonance imaging (MRI), a computed tomography (CT), scanners, and ultrasonic devices), navigation devices, Global Navigation Satellite System (GNSS), event data recorders (EDRs), flight data recorders (FDRs), vehicle infotainment devices, electronic equipment for vessels (e.g., navigation systems and gyrocompasses), avionics, security devices, head units for vehicles, industrial or home robots, automatic teller's machines (ATMs), points of sales (POSs) of stores, or internet of things (e.g., light bulbs, various sensors, electric or gas meters, sprinkler devices, fire alarms, thermostats, street lamps, toasters, exercise equipment, hot water tanks, heaters, boilers, and the like) or the like, but is not limited thereto.

According to an embodiment, the electronic device may include at least one of parts of furniture or buildings/structures, electronic boards, electronic signature receiving devices, projectors, or various measuring instruments (e.g., water meters, electricity meters, gas meters, or wave meters, and the like) or the like, but is not limited thereto. According to various embodiments, the electronic device may be one of the above-described devices or a combination thereof. An electronic device according to an embodiment may be a flexible electronic device. Furthermore, an electronic device according to an embodiment of this disclosure may not be limited to the above-described electronic devices and may include other electronic devices and new electronic devices according to the development of technologies.

Hereinafter, electronic devices according to various embodiments will be described with reference to the accompanying drawings. In this disclosure, the term “user” may refer to a person who uses an electronic device or may refer to a device (e.g., an artificial intelligence electronic device) that uses the electronic device.

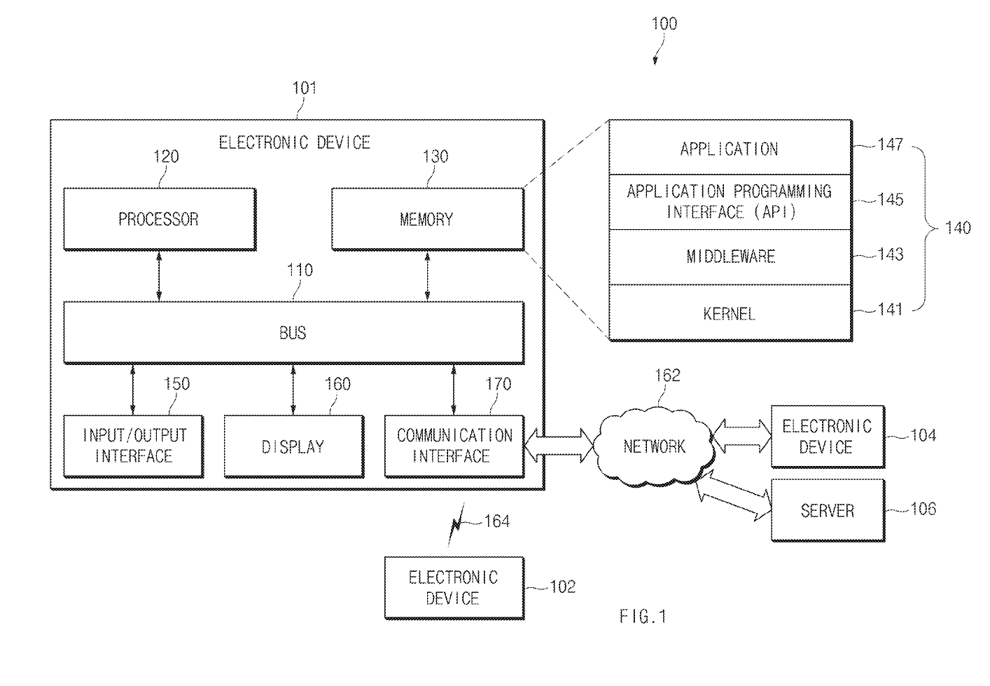

FIG. 1 is a diagram illustrating an example electronic device in a network environment, according to various example embodiments.

Referring to FIG. 1, according to various embodiments, an electronic device 101, 102, or 104, or a server 106 may be connected each other over a network 162 or a local wireless communication 164. The electronic device 101 may include a bus 110, a processor (e.g., including processing circuitry) 120, a memory 130, an input/output interface (e.g., including input/output circuitry) 150, a display 160, and a communication interface (e.g., including communication circuitry) 170. According to an embodiment, the electronic device 101 may not include at least one of the above-described elements or may further include other element(s).

For example, the bus 110 may interconnect the above-described elements 110 to 170 and may include a circuit for conveying communications (e.g., a control message and/or data) among the above-described elements.

The processor 120 may include various processing circuitry, such as, for example, and without limitation, one or more of a dedicated processor, a central processing unit (CPU), an application processor (AP), or a communication processor (CP). For example, the processor 120 may perform an arithmetic operation or data processing associated with control and/or communication of at least other elements of the electronic device 101.

The memory 130 may include a volatile and/or nonvolatile memory. For example, the memory 130 may store instructions or data associated with at least one other element(s) of the electronic device 101. According to an embodiment, the memory 130 may store software and/or a program 140. The program 140 may include, for example, a kernel 141, a middleware 143, an application programming interface (API) 145, and/or an application program (or “an application”) 147. At least a part of the kernel 141, the middleware 143, or the API 145 may be referred to as an “operating system (OS)”.

For example, the kernel 141 may control or manage system resources (e.g., the bus 110, the processor 120, the memory 130, and the like) that are used to execute operations or functions of other programs (e.g., the middleware 143, the API 145, and the application program 147). Furthermore, the kernel 141 may provide an interface that allows the middleware 143, the API 145, or the application program 147 to access discrete elements of the electronic device 101 so as to control or manage system resources.

The middleware 143 may perform, for example, a mediation role such that the API 145 or the application program 147 communicates with the kernel 141 to exchange data.

Furthermore, the middleware 143 may process task requests received from the application program 147 according to a priority. For example, the middleware 143 may assign the priority, which makes it possible to use a system resource (e.g., the bus 110, the processor 120, the memory 130, or the like) of the electronic device 101, to at least one of the application program 147. For example, the middleware 143 may process the one or more task requests according to the priority assigned to the at least one, which makes it possible to perform scheduling or load balancing on the one or more task requests.

The API 145 may be, for example, an interface through which the application program 147 controls a function provided by the kernel 141 or the middleware 143, and may include, for example, at least one interface or function (e.g., an instruction) for a file control, a window control, image processing, a character control, or the like.

The input/output interface 150 may include various input/output circuitry and play a role, for example, of an interface which transmits an instruction or data input from a user or another external device, to other element(s) of the electronic device 101. Furthermore, the input/output interface 150 may output an instruction or data, received from other element(s) of the electronic device 101, to a user or another external device.

The display 160 may include, for example, a liquid crystal display (LCD), a light-emitting diode (LED) display, an organic LED (OLED) display, a microelectromechanical systems (MEMS) display, or an electronic paper display or the like, but is not limited thereto. The display 160 may display, for example, various contents (e.g., a text, an image, a video, an icon, a symbol, and the like) to a user. The display 160 may include a touch screen and may receive, for example, a touch, gesture, proximity, or hovering input using an electronic pen or a part of a user's body.

For example, the communication interface 170 may include various communication circuitry and establish communication between the electronic device 101 and an external device (e.g., the first external electronic device 102, the second external electronic device 104, or the server 106). For example, the communication interface 170 may be connected to the network 162 over wireless communication or wired communication to communicate with the external device (e.g., the external second electronic device 104 or the server 106). Additionally, the communication interface 170 may establish a short-range wireless communication connection 164 with an external electronic device (e.g., first external electronic device 102).

The wireless communication may use at least one of, for example, long-term evolution (LTE), LTE Advanced (LTE-A), Code Division Multiple Access (CDMA), Wideband CDMA (WCDMA), Universal Mobile Telecommunications System (UMTS), Wireless Broadband (WiBro), Global System for Mobile Communications (GSM), or the like, as cellular communication protocol. According to an embodiment, the wireless communication may include the short range communication 164. For example, the short range communication 164 may include wireless fidelity (Wi-Fi), Bluetooth, near field communication (NFC), or magnetic secure transmission or magnetic stripe transmission (MST). According to an embodiment, the wireless communication may include a global navigation satellite system (GNSS).

The MST may generate a pulse depending on transmission data using an electromagnetic signal, and the pulse may generate a magnetic field signal. The electronic device 101 may transfer the magnetic field signal to point of sale (POS), and the POS may detect the magnetic field signal using a magnetic stripe reader (MSR). The POS may recover the data by converting the detected magnetic field signal to an electrical signal.

The GNSS may include at least one of, for example, a global positioning system (GPS), a global navigation satellite system (Glonass), a Beidou navigation satellite system (hereinafter referred to as “Beidou”), or an European global satellite-based navigation system (hereinafter referred to as “Galileo”) based on an available region, a bandwidth, or the like. Hereinafter, in this disclosure, “GPS” and “GNSS” may be interchangeably used. The wired communication may include at least one of, for example, a universal serial bus (USB), a high definition multimedia interface (HDMI), a recommended standard-232 (RS-232), a plain old telephone service (POTS), or the like. The network 162 may include at least one of telecommunications networks, for example, a computer network (e.g., LAN or WAN), an Internet, or a telephone network.

Each of the first and second external electronic devices 102 and 104 may be a device of which the type is different from or the same as that of the electronic device 101. According to an embodiment, the server 106 may include a group of one or more servers. According to various embodiments, all or a portion of operations that the electronic device 101 will perform may be executed by another or plural electronic devices (e.g., the electronic device 102 or 104 or the server 106). According to an embodiment, in the case where the electronic device 101 executes any function or service automatically or in response to a request, the electronic device 101 may not perform the function or the service internally, but, alternatively additionally, it may request at least a portion of a function associated with the electronic device 101 from another device (e.g., the electronic device 102 or 104 or the server 106). The other electronic device (e.g., the electronic device 102 or 104 or the server 106) may execute the requested function or additional function and may transmit the execution result to the electronic device 101. The electronic device 101 may provide the requested function or service using the received result or may additionally process the received result to provide the requested function or service. To this end, for example, cloud computing, distributed computing, or client-server computing may be used.

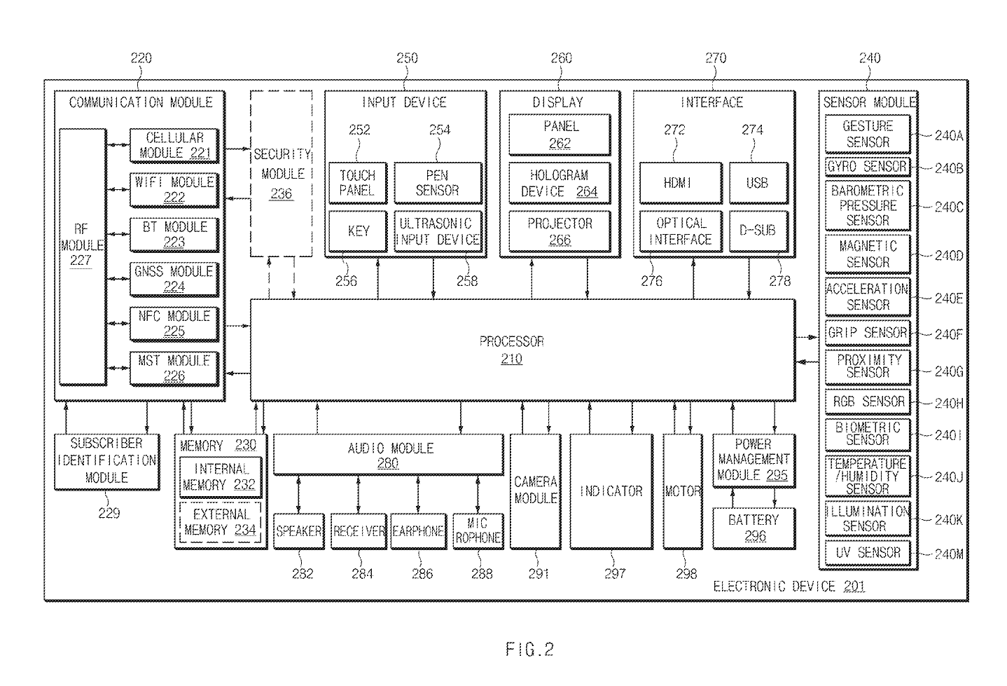

FIG. 2 is a block diagram illustrating an example electronic device, according to various example embodiments.

Referring to FIG. 2, an electronic device 201 may include, for example, all or a part of the electronic device 101 illustrated in FIG. 1. The electronic device 201 may include one or more processors (e.g., an application processor (AP)) (e.g., including processing circuitry) 210, a communication module (e.g., including communication circuitry) 220, a subscriber identification module 229, a memory 230, a security module, 236, a sensor module 240, an input device (e.g., including input circuitry) 250, a display 260, an interface (e.g., including interface circuitry) 270, an audio module 280, a camera module 291, a power management module 295, a battery 296, an indicator 297, and a motor 298.

The processor 210 may include various processing circuitry and drive, for example, an operating system (OS) or an application to control a plurality of hardware or software elements connected to the processor 210 and may process and compute a variety of data. For example, the processor 210 may be implemented with a System on Chip (SoC). According to an embodiment, the processor 210 may further include a graphic processing unit (GPU) and/or an image signal processor. The processor 210 may include at least a part (e.g., a cellular module 221) of elements illustrated in FIG. 2. The processor 210 may load an instruction or data, which is received from at least one of other elements (e.g., a nonvolatile memory), into a volatile memory and process the loaded instruction or data. The processor 210 may store a variety of data in the nonvolatile memory.

The communication module 220 may be configured the same as or similar to the communication interface 170 of FIG. 1. For example, the communication module 220 may include various communication circuitry, such as, for example, and without limitation, the cellular module 221, a Wi-Fi module 222, a Bluetooth (BT) module 223, a GNSS module 224 (e.g., a GPS module, a Glonass module, a Beidou module, or a Galileo module), a near field communication (NFC) module 225, a MST module 226 and a radio frequency (RF) module 227.

The cellular module 221 may provide, for example, voice communication, video communication, a character service, an Internet service, or the like over a communication network. According to an embodiment, the cellular module 221 may perform discrimination and authentication of the electronic device 201 within a communication network using the subscriber identification module (e.g., a SIM card) 229. According to an embodiment, the cellular module 221 may perform at least a portion of functions that the processor 210 provides. According to an embodiment, the cellular module 221 may include a communication processor (CP).

Each of the Wi-Fi module 222, the BT module 223, the GNSS module 224, the NFC module 225, or the MST module 226 may include a processor for processing data exchanged through a corresponding module, for example. According to an embodiment, at least a part (e.g., two or more) of the cellular module 221, the Wi-Fi module 222, the BT module 223, the GNSS module 224, the NFC module 225, or the MST module 226 may be included within one Integrated Circuit (IC) or an IC package.

For example, the RF module 227 may transmit and receive a communication signal (e.g., an RF signal). For example, the RF module 227 may include a transceiver, a power amplifier module (PAM), a frequency filter, a low noise amplifier (LNA), an antenna, or the like. According to another embodiment, at least one of the cellular module 221, the Wi-Fi module 222, the BT module 223, the GNSS module 224, the NFC module 225, or the MST module 226 may transmit and receive an RF signal through a separate RF module.

The subscriber identification module 229 may include, for example, a card and/or embedded SIM that includes a subscriber identification module and may include unique identity information (e.g., integrated circuit card identifier (ICCID)) or subscriber information (e.g., integrated mobile subscriber identity (IMSI)).

The memory 230 (e.g., the memory 130) may include an internal memory 232 and/or an external memory 234. For example, the internal memory 232 may include at least one of a volatile memory (e.g., a dynamic random access memory (DRAM), a static RAM (SRAM), a synchronous DRAM (SDRAM), or the like), a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory), or the like), a hard drive, or a solid state drive (SSD).

The external memory 234 may further include a flash drive such as compact flash (CF), secure digital (SD), micro secure digital (Micro-SD), mini secure digital (Mini-SD), extreme digital (xD), a multimedia card (MMC), a memory stick, or the like. The external memory 234 may be operatively and/or physically connected to the electronic device 201 through various interfaces.

A security module 236 may be a module that includes a storage space of which a security level is higher than that of the memory 230 and may be a circuit that guarantees safe data storage and a protected execution environment. The security module 236 may be implemented with a separate circuit and may include a separate processor. For example, the security module 236 may be in a smart chip or a secure digital (SD) card, which is removable, or may include an embedded secure element (eSE) embedded in a fixed chip of the electronic device 201. Furthermore, the security module 236 may operate based on an operating system (OS) that is different from the OS of the electronic device 201. For example, the security module 236 may operate based on Java card open platform (JCOP) OS.

The sensor module 240 may measure, for example, a physical quantity or may detect an operation state of the electronic device 201. The sensor module 240 may convert the measured or detected information to an electrical signal. For example, the sensor module 240 may include at least one of a gesture sensor 240A, a gyro sensor 240B, a barometric pressure sensor 240C, a magnetic sensor 240D, an acceleration sensor 240E, a grip sensor 240F, the proximity sensor 240G, a color sensor 240H (e.g., red, green, blue (RGB) sensor), a biometric sensor 240I, a temperature/humidity sensor 240J, an illuminance (e.g., illumination) sensor 240K, or an UV sensor 240M. Although not illustrated, additionally or generally, the sensor module 240 may further include, for example, an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit for controlling at least one or more sensors included therein. According to an embodiment, the electronic device 201 may further include a processor that is a part of the processor 210 or independent of the processor 210 and is configured to control the sensor module 240. The processor may control the sensor module 240 while the processor 210 remains at a sleep state.

The input device 250 may include various input circuitry, such as, for example, and without limitation, a touch panel 252, a (digital) pen sensor 254, a key 256, or an ultrasonic input unit 258. For example, the touch panel 252 may use at least one of capacitive, resistive, infrared and ultrasonic detecting methods. Also, the touch panel 252 may further include a control circuit. The touch panel 252 may further include a tactile layer to provide a tactile reaction to a user.

The (digital) pen sensor 254 may be, for example, a part of a touch panel or may include an additional sheet for recognition. The key 256 may include, for example, a physical button, an optical key, a keypad, or the like. The ultrasonic input device 258 may detect (or sense) an ultrasonic signal, which is generated from an input device, through a microphone (e.g., a microphone 288) and may check data corresponding to the detected ultrasonic signal.

The display 260 (e.g., the display 160) may include a panel 262, a hologram device 264, or a projector 266. The panel 262 may be the same as or similar to the display 160 illustrated in FIG. 1. The panel 262 may be implemented, for example, to be flexible, transparent or wearable. The panel 262 and the touch panel 252 may be integrated into a single module. The hologram device 264 may display a stereoscopic image in a space using a light interference phenomenon. The projector 266 may project light onto a screen so as to display an image. For example, the screen may be arranged in the inside or the outside of the electronic device 201. According to an embodiment, the display 260 may further include a control circuit for controlling the panel 262, the hologram device 264, or the projector 266.

The interface 270 may include various interface circuitry, such as, for example, and without limitation, a high-definition multimedia interface (HDMI) 272, a universal serial bus (USB) 274, an optical interface 276, or a D-subminiature (D-sub) 278. The interface 270 may be included, for example, in the communication interface 170 illustrated in FIG. 1. Additionally or generally, the interface 270 may include, for example, a mobile high definition link (MHL) interface, a SD card/multi-media card (MMC) interface, or an infrared data association (IrDA) standard interface.

The audio module 280 may convert a sound and an electric signal in dual directions. At least a part of the audio module 280 may be included, for example, in the input/output interface 150 illustrated in FIG. 1. The audio module 280 may process, for example, sound information that is input or output through a speaker 282, a receiver 284, an earphone 286, or the microphone 288.

For example, the camera module 291 may shoot a still image or a video. According to an embodiment, the camera module 291 may include at least one or more image sensors (e.g., a front sensor or a rear sensor), a lens, an image signal processor (ISP), or a flash (e.g., an LED or a xenon lamp).

The power management module 295 may manage, for example, power of the electronic device 201. According to an embodiment, a power management integrated circuit (PMIC), a charger IC, or a battery or fuel gauge may be included in the power management module 295. The PMIC may have a wired charging method and/or a wireless charging method. The wireless charging method may include, for example, a magnetic resonance method, a magnetic induction method or an electromagnetic method and may further include an additional circuit, for example, a coil loop, a resonant circuit, or a rectifier, and the like. The battery gauge may measure, for example, a remaining capacity of the battery 296 and a voltage, current or temperature thereof while the battery is charged. The battery 296 may include, for example, a rechargeable battery and/or a solar battery.

The indicator 297 may display a specific state of the electronic device 201 or a part thereof (e.g., the processor 210), such as a booting state, a message state, a charging state, and the like. The motor 298 may convert an electrical signal into a mechanical vibration and may generate the following effects: vibration, haptic, and the like. Although not illustrated, a processing device (e.g., a GPU) for supporting a mobile TV may be included in the electronic device 201. The processing device for supporting the mobile TV may process media data according to the standards of digital multimedia broadcasting (DMB), digital video broadcasting (DVB), MediaFlo™, or the like.

Each of the above-mentioned elements of the electronic device according to various embodiments of the present disclosure may be configured with one or more components, and the names of the elements may be changed according to the type of the electronic device. In various embodiments, the electronic device may include at least one of the above-mentioned elements, and some elements may be omitted or other additional elements may be added. Furthermore, some of the elements of the electronic device according to various embodiments may be combined with each other so as to form one entity, so that the functions of the elements may be performed in the same manner as before the combination.

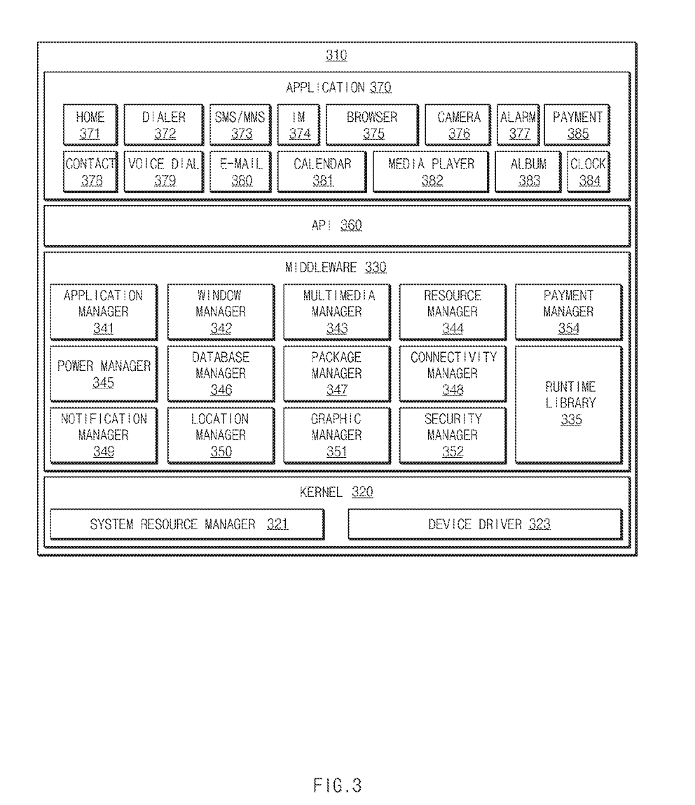

FIG. 3 is a block diagram illustrating an example program module, according to various example embodiments.

According to an embodiment, a program module 310 (e.g., the program 140) may include an operating system (OS) to control resources associated with an electronic device (e.g., the electronic device 101), and/or diverse applications (e.g., the application program 147) driven on the OS. The OS may be, for example, Android, iOS, Windows, Symbian, or Tizen.

The program module 310 may include a kernel 320, a middleware 330, an application programming interface (API) 360, and/or an application 370. At least a portion of the program module 310 may be preloaded on an electronic device or may be downloadable from an external electronic device (e.g., the electronic device 102 or 104, the server 106, or the like).

The kernel 320 (e.g., the kernel 141) may include, for example, a system resource manager 321 or a device driver 323. The system resource manager 321 may perform control, allocation, or retrieval of system resources. According to an embodiment, the system resource manager 321 may include a process managing unit, a memory managing unit, or a file system managing unit. The device driver 323 may include, for example, a display driver, a camera driver, a Bluetooth driver, a shared memory driver, a USB driver, a keypad driver, a Wi-Fi driver, an audio driver, or an inter-process communication (IPC) driver.

The middleware 330 may provide, for example, a function that the application 370 needs in common, or may provide diverse functions to the application 370 through the API 360 to allow the application 370 to efficiently use limited system resources of the electronic device. According to an embodiment, the middleware 330 (e.g., the middleware 143) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352, or a payment manager 354.

The runtime library 335 may include, for example, a library module that is used by a compiler to add a new function through a programming language while the application 370 is being executed. The runtime library 335 may perform input/output management, memory management, or capacities about arithmetic functions.

The application manager 341 may manage, for example, a life cycle of at least one application of the application 370. The window manager 342 may manage a graphic user interface (GUI) resource that is used in a screen. The multimedia manager 343 may identify a format necessary for playing diverse media files, and may perform encoding or decoding of media files using a codec suitable for the format. The resource manager 344 may manage resources such as a storage space, memory, or source code of at least one application of the application 370.

The power manager 345 may operate, for example, with a basic input/output system (BIOS) to manage a battery or power, and may provide power information for an operation of an electronic device. The database manager 346 may generate, search for, or modify database that is to be used in at least one application of the application 370. The package manager 347 may install or update an application that is distributed in the form of package file.

The connectivity manager 348 may manage, for example, wireless connection such as Wi-Fi or Bluetooth. The notification manager 349 may display or notify an event such as arrival message, appointment, or proximity notification in a mode that does not disturb a user. The location manager 350 may manage location information about an electronic device. The graphic manager 351 may manage a graphic effect that is provided to a user, or manage a user interface relevant thereto. The security manager 352 may provide a general security function necessary for system security, user authentication, or the like. According to an embodiment, in the case where an electronic device (e.g., the electronic device 101) includes a telephony function, the middleware 330 may further include a telephony manager for managing a voice or video call function of the electronic device.

The middleware 330 may include a middleware module that combines diverse functions of the above-described elements. The middleware 330 may provide a module specialized to each OS kind to provide differentiated functions. Additionally, the middleware 330 may dynamically remove a part of the preexisting elements or may add new elements thereto.

The API 360 (e.g., the API 145) may be, for example, a set of programming functions and may be provided with a configuration that is variable depending on an OS. For example, in the case where an OS is the android or the iOS, it may provide one API set per platform. In the case where an OS is the tizen, it may provide two or more API sets per platform.

The application 370 (e.g., the application program 147) may include, for example, one or more applications capable of providing functions for a home 371, a dialer 372, an SMS/MMS 373, an instant message (IM) 374, a browser 375, a camera 376, an alarm 377, a contact 378, a voice dial 379, an e-mail 380, a calendar 381, a media player 382, an album 383, a clock 384, and a payment 385. Additionally, although not shown, the application 370 may include various other applications, such as, for example, and without limitation, a health care (e.g., measuring an exercise quantity, blood sugar, or the like) or offering of environment information (e.g., information of barometric pressure, humidity, temperature, or the like).

According to an embodiment, the application 370 may include an application (hereinafter referred to as “information exchanging application” for descriptive convenience) to support information exchange between an electronic device (e.g., the electronic device 101) and an external electronic device (e.g., the electronic device 102 or 104). The information exchanging application may include, for example, a notification relay application for transmitting specific information to an external electronic device, or a device management application for managing the external electronic device.

For example, the notification relay application may include a function of transmitting notification information, which arise from other applications (e.g., applications for SMS/MMS, e-mail, health care, or environmental information), to an external electronic device (e.g., the electronic device 102 or 104). Additionally, the information exchanging application may receive, for example, notification information from an external electronic device and provide the notification information to a user.

The device management application may manage (e.g., install, delete, or update), for example, at least one function (e.g., turn-on/turn-off of an external electronic device itself (or a part of elements) or adjustment of brightness (or resolution) of a display) of the external electronic device (e.g., the electronic device 102 or 104) which communicates with the electronic device, an application running in the external electronic device, or a service (e.g., a call service, a message service, or the like) provided from the external electronic device.

According to an embodiment, the application 370 may include an application (e.g., a health care application of a mobile medical device) that is assigned in accordance with an attribute of an external electronic device (e.g., the electronic device 102 or 104). According to an embodiment, the application 370 may include an application that is received from an external electronic device (e.g., the server 106 or the electronic device 102 or 104). According to an embodiment, the application 370 may include a preloaded application or a third party application that is downloadable from a server. The names of elements of the program module 310 according to the embodiment may be modifiable depending on kinds of operating systems.

According to various embodiments, at least a portion of the program module 310 may be implemented by software, firmware, hardware, or a combination of two or more thereof. At least a portion of the program module 310 may be implemented (e.g., executed), for example, by the processor (e.g., the processor 210). At least a portion of the program module 310 may include, for example, modules, programs, routines, sets of instructions, processes, or the like for performing one or more functions.

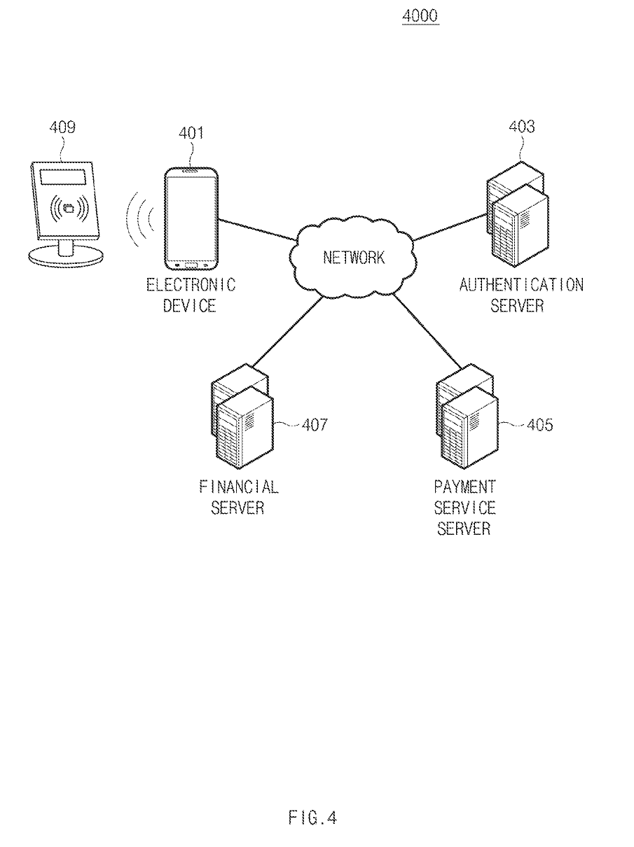

FIG. 4 is a diagram illustrating an example operating environment of an electronic device, according to an example embodiment.

Referring to FIG. 4, a payment system 4000 may include an electronic device 401, a fast identity online (FIDO) server (e.g., an authentication server) 403, a payment service server 405, a financial server 407, and a payment device 409. Each of elements included in the payment system 4000 illustrated in FIG. 1 may be connected with each other over a network. For example, the electronic device 401, the authentication server 403, the payment service server 405, and the financial server 407 may be connected with each other through a mobile communication network or an Internet network. As another example, the electronic device 401 and the payment device 409 may be connected with each other through near field communication (NFC), wireless-fidelity (Wi-Fi), magnetic secure transmission (MST), or the like.

According to various embodiments, the payment system 4000 may perform user authentication, which is required in the registration of payment information, the deletion of payment information, or a payment procedure, with an external server.

According to various embodiments, the electronic device 401 may be a device capable of making a payment (or withdrawal). A user may make a payment online or offline using the electronic device 401.

According to an example embodiment, the electronic device 401 may provide a payment service using a payment application (e.g., Samsung Pay™ Application). According to an embodiment, the payment application may provide a user interface associated with the payment. For example, the payment application may provide a user interface associated with card registration, a payment, or a transaction. Moreover, the payment application may provide, for example, an interface associated with user authentication through identification and verification (ID&V).

According to an example embodiment, the electronic device 401 may store card information (or account information) associated with a payment service account (e.g., Samsung account), a biometric authentication service account, and a user account.

According to an example embodiment, the electronic device 401 may perform user authentication through a biometric authentication operation. If a payment request is received from the user, the electronic device 401 may perform biometric authentication through the authentication server 403.

According to an example embodiment, the electronic device 401 may make a request for a payment token to the payment service server 405. According to an embodiment, the electronic device 401 may make a payment (or withdrawal) using a payment token issued by the financial server 407.

According to an example embodiment, the authentication server 403 may perform user authentication in response to the request of the electronic device 401. The authentication server 403 may provide a FIDO authentication service for performing user authentication using the biometric information of the user. The authentication server 403 may perform user authentication using authentication information received from the electronic device 401. When the user authentication is completed, the authentication server 403 may transmit the authentication result to the electronic device 401.

According to an example embodiment, the payment service server 405 may exchange information with the electronic device 401 and the financial server 407. The payment service server 405 may manage card information (or account information) associated with a payment service account (e.g., Samsung account), a biometric authentication service account, and a user account.

According to an example embodiment, when the electronic device 401 requests the payment token, the payment service server 405 may transmit a request for the payment token to the financial server 407. The payment service server 405 may transmit the request for the payment token and a session key for biometric authentication received from the electronic device 401 to the financial server 407. The payment service server 405 may transmit the payment token received from the financial server 407 to the electronic device 401.

According to an example embodiment, the financial server 407 may be a server, which is operated by a financial institution, such as a card company, a bank, or the like. The financial server 407 may issue a card and may manage card information (or account information). After all, the financial server 407 may determine whether the payment is made.

According to an example embodiment, the financial server 407 may generate the payment token. The financial server 407 may transmit the generated payment token to the electronic device 401 through the payment service server 405. According to various embodiments, the payment token may be generated by a token server independent of the financial server 407.

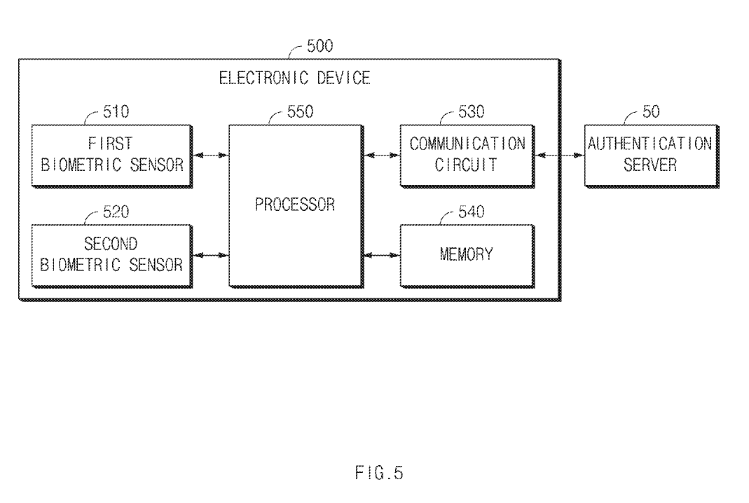

FIG. 5 is a block diagram illustrating an example configuration of the electronic device, according to an example embodiment;

Referring to FIG. 5, an electronic device 500 according to an embodiment may include a first biometric sensor 510 (or a first biometric information sensor), a second biometric sensor 520 (or a second biometric information sensor), a communication circuit 530 (or a wireless communication circuit), a memory 540, and/or a processor (e.g., including processing circuitry) 550. The electronic device 500 according to an embodiment may include a housing, and the first biometric sensor 510, the second biometric sensor 520, the communication circuit 530, the memory 540, and/or the processor 550 may be disposed in the housing.

According to an embodiment, the electronic device 500 may include a plurality of biometric sensors, each of which sense different types of pieces of biometric information, for example, the first biometric sensor 510 and the second biometric sensor 520. The electronic device 500 is illustrated in FIG. 5 as including two biometric sensors 510 and 520. However, embodiments are not limited thereto. For example, the electronic device 500 may include three or more biometric sensors.

According to various embodiments, the first biometric sensor 510 may be disposed in a part of the housing. The first biometric sensor 510 may be one of various types of biometric sensors such as a fingerprint sensor, an iris sensor, a vein sensor, and the like. For example, the first biometric sensor 510 may be the fingerprint sensor. The fingerprint sensor may detect the fingerprint of the finger of a user. For example, the fingerprint sensor may capture the fingerprint image of the finger. The fingerprint sensor may be an optical, ultrasonic, or capacitive sensor. As another example, the fingerprint sensor may be a sensor in an area manner in which the fingerprint is recognized in units of an area or a swipe manner in which the fingerprint is recognized in units of a line.

According to various embodiments, an IC (hereinafter called a “fingerprint sensor IC”) embedded in the fingerprint sensor may scan an area in which a specific fingerprint is detected. The fingerprint sensor IC may capture the fingerprint image through the scanning. For example, the fingerprint sensor IC may extract a unique feature of the fingerprint from the fingerprint image, may convert the extracted feature into a digital value, and may provide the digital value to the processor 550. For example, the extracted feature, for example, fingerprint minutiae may include various minutiae such as ridge ending, crossover, bifurcation, or pore, or the like included in the fingerprint.

According to various embodiments, the second biometric sensor 520 may be disposed in a part of the housing. The second biometric sensor 520 may be one of various types of biometric sensors such as a fingerprint sensor, an iris sensor, a vein sensor, and the like. The second biometric sensor 520 may be a sensor sensing a type of biometric information different from that of the first biometric sensor 510. According to an embodiment, the second biometric sensor 520 may be an iris sensor (or an iris recognition scanner). The iris sensor may analyze the wrinkles formed in the iris of the user and may provide the analyzed result to the processor 550.

For example, the iris sensor may include a light source irradiating specific light (e.g., infrared light or the like) to the iris of a user, a camera capturing an iris image based on the light reflected from the iris, and/or an image processing IC analyzing or encoding minutiae (or a pattern) included in the iris image. The image processing IC may provide the analyzed result to the processor 550. According to various embodiments, a camera capturing the iris image may be an iris capture dedicated (infrared light) camera or may correspond to the front camera of the electronic device 500.

Hereinafter, for convenience of description and by way of non-limiting example, it is assumed that the first biometric sensor 510 is a fingerprint sensor and the second biometric sensor 520 is an iris sensor.

According to an embodiment, the communication circuit 530 may be disposed in the housing. The communication circuit 530 may communicate with an authentication server 50. For example, the authentication server 50 may be a FIDO server. The communication circuit 530 may be connected with the authentication server 50 through a mobile communication network or an Internet network. The communication circuit 530 may transmit data to the authentication server 50 and may receive data from the authentication server 50. For example, the communication circuit 530 may be the cellular module 221 or the Wi-Fi module 222 illustrated in FIG. 2.

According to various embodiments, the memory 540 may store an instruction, information, and/or data associated with the operations of the elements 510, 520, 530, and 550 included in the electronic device 500. For example, the memory 540 may store instructions, when executed, that cause the processor 550 to perform various operations described in the present disclosure. For example, the instructions may be implemented with software such as an application program (e.g., a payment application), OS, or firmware so as to be stored in the memory 540 or so as to be embedded in hardware. The memory 540 may store the payment application that makes a payment.

According to an embodiment, the processor 550 may be electrically connected with the first biometric sensor 510, the second biometric sensor 520, the communication circuit 530, and the memory 540. For example, the processor 550 may be electrically connected with the elements 510 to 540 included in the electronic device 500 and may perform an arithmetic operation or data processing associated with control and/or communication of the elements 510 to 540 included in the electronic device 500. According to an embodiment, the processor 550 may execute (or launch) a payment application (e.g., “Samsung Pay™”) for a payment transaction according to various embodiments of the present disclosure.

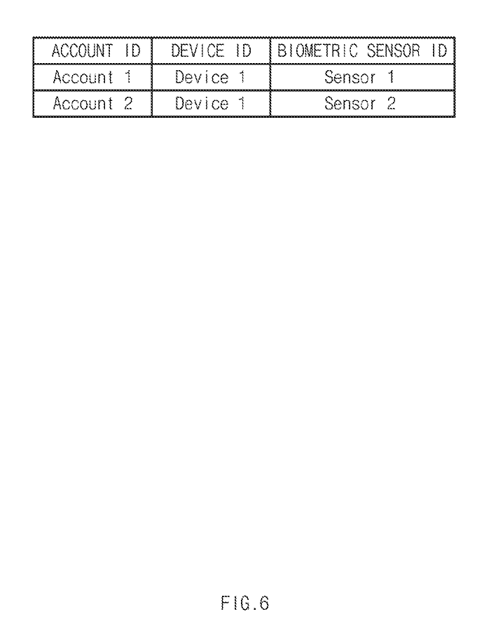

According to an embodiment, the processor 550 may generate pieces of account information respectively corresponding to a plurality of biometric sensors. The processor 550 may generate first account information corresponding to the first biometric sensor 510 and second account information corresponding to the second biometric sensor 520. If a specified condition is satisfied, the processor 550 may generate the first account information and the second account information. For example, when performing authentication first, the processor 550 may generate the first account information and the second account information. For example, when performing first authentication associated with fingerprint information, the processor 550 may generate the first account information. When performing first authentication associated with iris information, the processor 550 may generate the second account information. For example, an account generated by the processor 550 may be a biometric authentication service account (e.g., a FIDO service account). The first account information and/or the second account information may be stored in the memory 540. The example account information generated by the electronic device 500 will be described in greater detail below with reference to FIG. 6.

According to an embodiment, the processor 550 may make a request for authentication associated with biometric information corresponding to account information to the authentication server 50 using account information, which corresponds to biometric information to be authenticated, from among pieces of account information. For example, the processor 550 may make a request for the authentication of fingerprint information using the first account information and may make a request for the authentication of iris information using the second account information. For example, if the payment application is executed, the processor 550 may make a request for authentication to the authentication server 50. For example, while executing the payment application, the processor 550 may allow at least one of the first biometric sensor 510 or the second biometric sensor 520 to perform the user authentication. When the processor 550 requests authentication, the processor 550 may transmit account information (e.g., the first account information or the second account information) corresponding to biometric information to be authenticated to the authentication server 50.

According to an embodiment, the processor 550 may make a request for the authentication of biometric information, of which the frequency of use is relatively high, from among a plurality of types of pieces of biometric information, which are sensed by a plurality of biometric sensors, to the authentication server 50. For example, in the case where the frequency of use of the fingerprint information is higher than the frequency of use of the iris information, the processor 550 may make a request for the authentication of fingerprint information using the first account information. The traffic of a network used for authentication may be reduced by preferentially making a request for the authentication of biometric information of which the frequency of use is high.

According to an embodiment, the processor 550 may make a request for the authentication of biometric information, of which the type is selected by the user of the electronic device 500, from among a plurality of types of pieces of biometric information, which are sensed by a plurality of biometric sensors, to the authentication server 50. For example, if the payment application is executed, the processor 550 may output a user interface for selecting one of a plurality of types of pieces of biometric information to a touch screen display (not illustrated) exposed through a part of the housing. For example, if the iris information is selected through a user interface, the processor 550 may make a request for the authentication of the iris information using the second account information.

According to an embodiment, the processor 550 may determine whether account information is registered in the authentication server 50, based on information received from the authentication server 50 upon requesting the authentication. For example, if account information and nonce are received from the authentication server 50, the processor 550 may determine that the account information is registered in the authentication server 50. In cryptography the term nonce may be an arbitrary number that may only be used once as part of an authentication procedure. As another example, if an error code is received from the authentication server 50 in response to the request, the processor 550 may determine that account information is unregistered in the authentication server 50.

According to an embodiment, in the case where the account information is registered in the authentication server 50, the processor 550 may obtain biometric information corresponding to the account information using a biometric sensor corresponding to the account information. For example, the processor 550 may receive the biometric information of the user using one biometric sensor of the first biometric sensor 510 or the second biometric sensor 520 and may perform user authentication. The processor 550 may authenticate biometric information corresponding to the account information in the electronic device 500 by comparing the obtained biometric information with the stored biometric information. If the obtained biometric information is the same as the stored biometric information, the processor 550 may transmit the authentication result of the electronic device 500 to the authentication server 50. The processor 550 may receive the response to the authentication request from the authentication server 50.

According to an embodiment, in the case where the account information is unregistered in the authentication server 50, the processor 550 may make a request for registration of the account information to the authentication server 50. The processor 550 may obtain biometric information corresponding to the account information in the electronic device 500 using a biometric sensor corresponding to the account information. The processor 550 may authenticate biometric information corresponding to the account information in the electronic device 500 by comparing the obtained biometric information with the stored biometric information. If the obtained biometric information is the same as the stored biometric information, the processor 550 may transmit the authentication result of the electronic device 500 to the authentication server 50. The processor 550 may receive the response to the registration request from the authentication server 50.

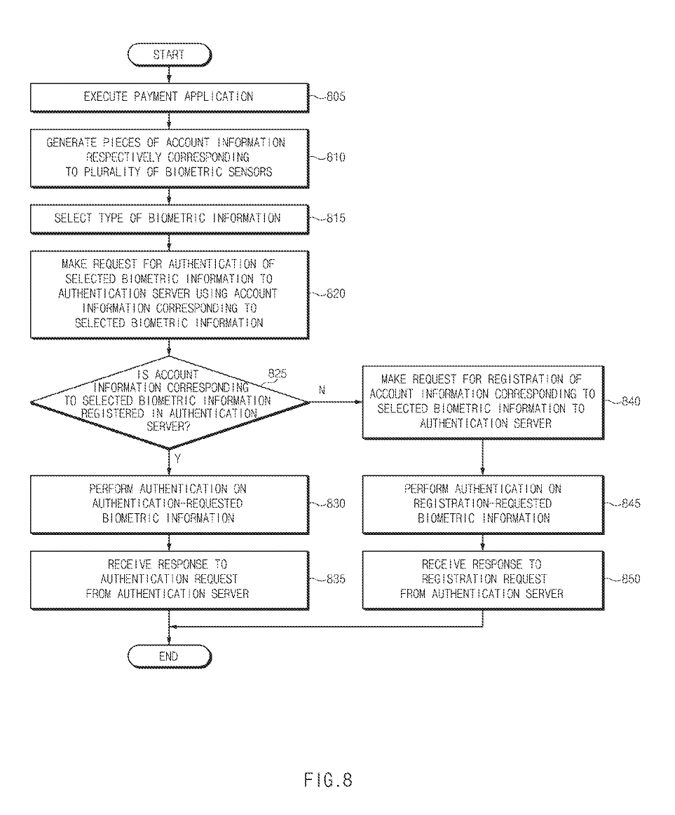

The authenticating and registering of the above-described biometric information will be described in greater detail below with reference to FIG. 8.

According to an embodiment, if one of pieces of biometric information stored in the memory 540 is changed, the processor 550 may delete only the account information, which corresponds to the changed biometric information, from among the pieces of account information. Since pieces of account information respectively corresponding to types of pieces of biometric information are generated, the processor 550 may delete only the account information corresponding to the changed biometric information. For example, if fingerprint information stored in the memory 540 is changed, the processor 550 may delete only the first account information, which corresponds to the fingerprint information, of the first account information and the second account information.

According to various embodiments, pieces of account information respectively corresponding to biometric sensors may be generated, thereby skipping an unnecessary authentication procedure and reducing the risk for management logic and unnecessary error handling.

FIG. 6 is a diagram illustrating example account information generated by an electronic device, according to an example embodiment. For convenience of description, a description will be given with reference to FIG. 5.

Referring to FIG. 6, account information may include the ID of an account, the ID of the electronic device 500, and the ID of a biometric sensor corresponding to the account information. For example, first account information may include the ID of the account “Account 1”, the ID of the electronic device 500 “Device 1”, and the ID of the first biometric sensor 510 “Sensor 1”. As another example, second account information may include the ID of the account “Account 2”, the ID of the electronic device 500 “Device 1”, and the ID of the second biometric sensor 520 “Sensor 2”. As illustrated in FIG. 6, the electronic device 500 may generate pieces of account information (the first account information and the second account information) respectively corresponding to a plurality of biometric sensors (the first biometric sensor 510 and the second biometric sensor 520). In the case where the electronic device 500 performs authentication on fingerprint information, the electronic device 500 may transmit the first account information to the authentication server 50. In the case where the electronic device 500 performs authentication on iris information, the electronic device 500 may transmit the second account information to the authentication server 50.

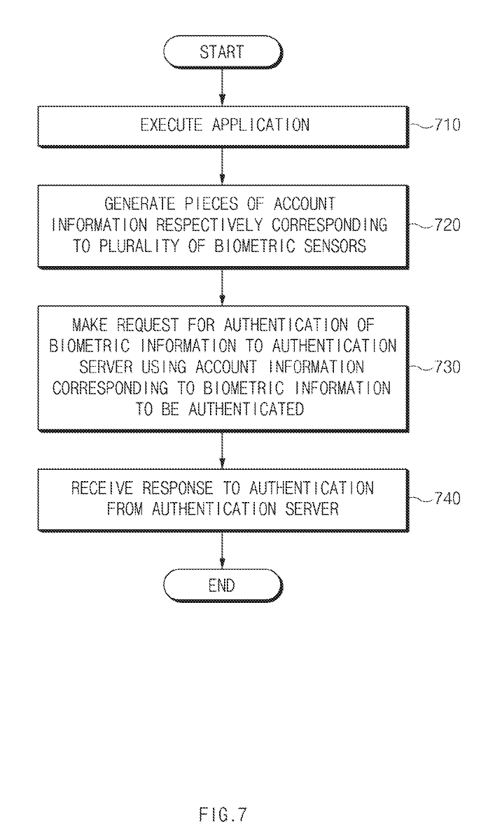

FIG. 7 is a flowchart illustrating an example biometric information authenticating method of an electronic device, according to an example embodiment.

Hereinafter, it is assumed by way of non-limiting example that the electronic device 500 of FIG. 5 performs a process of FIG. 7. In addition, as described in FIG. 7, it is understood that the operation described as being executed by the electronic device is controlled by the processor 550 of the electronic device 500.

Referring to FIG. 7, in operation 710, the electronic device may execute an application (e.g., a payment application). For example, the electronic device may execute or launch “Samsung Pay™” or the like being the payment application for making a payment. A graphic user interface (GUI) for making a payment may be output to the electronic device by execution of the payment application.

In operation 720, the electronic device may generate pieces of account information respectively corresponding to a plurality of biometric sensors. For example, the electronic device may generate first account information corresponding to a first biometric sensor and second account information corresponding to a second biometric sensor. For example, when authenticating first the biometric information obtained by the first biometric sensor, the electronic device may generate the first account information. Similarly, when authenticating first the biometric information obtained by the second biometric sensor, the electronic device may generate the second account information. After the first account information and the second account information are generated, operation 720 may be omitted.

In operation 730, the electronic device may make a request for the authentication of biometric information to an authentication server using the account information corresponding to the biometric information to be authenticated. For example, the electronic device may make a request for the authentication of all pieces of biometric information, which are sensed by the electronic device, for example, fingerprint information and/or iris information to the authentication server. When requesting the authentication, the electronic device may transmit the first account information and/or the second account information to the authentication server. As another example, if user authentication is completed using the iris among the fingerprint and the iris, the electronic device may make a request for the authentication of iris information to the authentication server. When requesting the authentication, the electronic device may transmit the second account information corresponding to iris information to the authentication server. According to an embodiment, the authentication server may transmit the nonce corresponding to the received account information to the electronic device in response to the authentication request. For example, in the case where the electronic device requests the authentication of the first account information and the second account information, the electronic device may receive the first nonce corresponding to the first account information and the second nonce corresponding to the second account information from the authentication server. The electronic device may obtain biometric information using biometric sensors corresponding to the first account information and the second account information. For example, the electronic device may perform authentication using biometric information obtained first from the fingerprint information and the iris information. For example, in the case where the fingerprint information is obtained first, the electronic device may compare the obtained fingerprint information with the stored fingerprint information. For example, in the case where the obtained fingerprint information is the same as the stored fingerprint information, the electronic device may sign the first nonce corresponding to fingerprint information and may transmit the first signed nonce to the authentication server.

In operation 740, the electronic device may receive the response to the authentication from the authentication server. For example, in the case where one of the fingerprint information and the iris information is authenticated, the electronic device may receive the response to the authenticated biometric information from the authentication server. If the response is received, the electronic device may make a payment. As another example, in the case where the iris information is authenticated, the electronic device may receive the response from the authentication server. If the response is received, the electronic device may make a payment. The detailed operation associated with the authentication will be described with reference to FIG. 8.

FIG. 8 is a flowchart illustrating an example biometric information authenticating method of an electronic device, according to an example embodiment.

Hereinafter, it is assumed that the electronic device 500 of FIG. 5 performs a process of FIG. 8. In addition, as described in FIG. 8, it is understood that the operation described as being executed by the electronic device is controlled by the processor 550 of the electronic device 500. For convenience of description, a description that is the same as or similar to an operation described with reference to FIG. 7 will not be repeated here.

Referring to FIG. 8, in operation 805, the electronic device may execute a payment application.

In operation 810, the electronic device may generate pieces of account information respectively corresponding to a plurality of biometric sensors.

In operation 815, the electronic device may select a type of the biometric information. For example, if the payment application is executed, the electronic device may output a GUI for selecting the type of the biometric information. The electronic device may select the type of the biometric information to be authenticated based on a user input to the user interface. Operation 815 may be omitted depending on implementation of the present disclosure.

In operation 820, the electronic device may make a request for the authentication of the selected biometric information to the authentication server using the account information corresponding to the selected biometric information. According to an embodiment, in the case where operation 815 is omitted, the electronic device may make a request for the authentication of all pieces of biometric information, which are sensed by the electronic device, for example, fingerprint information and iris information to the authentication server.

In operation 825, the electronic device may determine whether the account information corresponding to the selected biometric information is registered in the authentication server. For example, in the case where the account information is registered in the authentication server, the electronic device may receive the account information and nonce from the authentication server. As another example, in the case where the account information is unregistered in the authentication server, the electronic device may receive an error code from the authentication server. The electronic device may determine whether the account information is registered in the authentication server, based on information received from the authentication server. According to an embodiment, in the case where operation 815 is omitted, the electronic device may determine whether each of pieces of account information is registered in the authentication server.

In the case where the account information is registered in the authentication server, in operation 830, the electronic device may perform authentication on the authentication-requested biometric information. For example, the electronic device may authenticate the biometric information corresponding to the account information received from the authentication server in the electronic device. The electronic device may obtain biometric information using the biometric sensor corresponding to the account information and may compare the obtained biometric information with the stored biometric information. In the case where the obtained biometric information is the same as the stored biometric information, the electronic device may authenticate the biometric information. According to an embodiment, in the case where the number of types of authentication-requested biometric information is two or more, the electronic device may authenticate biometric information, which is sensed first by the electronic device, from among a plurality of types of pieces of biometric information. According to an embodiment, the electronic device may encrypt the result of user authentication using a private key associated with account information about the biometric sensor. According to an embodiment, if the biometric information is authenticated, the electronic device may sign the nonce, which is received together with the account information from the authentication server, using the private key corresponding to the account information. According to an embodiment, the electronic device may transmit the encrypted authentication result of to the outside using a communication circuit. According to an embodiment, if the biometric information is authenticated, the electronic device may transmit the account information, the signed nonce, and the ID of the biometric information corresponding to the account information to the authentication server.

In operation 835, the electronic device may receive the response to the authentication request from the authentication server. For example, the authentication server may verify the account information, the signed nonce, and the ID of the biometric information corresponding to the account information, which are received from the electronic device. The authentication server may verify the signed nonce by the public key. If the response to the authentication request is received, the electronic device may make a payment.

In the case where the account information is unregistered in the authentication server, in operation 840, the electronic device may make a request for registration of the account information corresponding to the selected biometric information to the authentication server. For example, the electronic device may make a request for the registration of the unregistered account information to the authentication server to use unregistered account information. The electronic device may receive the response to the registration request and the nonce from the authentication server.

In operation 845, the electronic device may perform authentication on the registration-requested biometric information. For example, the electronic device may authenticate the biometric information corresponding to the registration-requested account information in the electronic device. The electronic device may obtain biometric information using the biometric sensor corresponding to the registration-requested account information and may compare the obtained biometric information with the stored biometric information. In the case where the obtained biometric information is the same as the stored biometric information, the electronic device may authenticate the biometric information. According to an embodiment, in the case where the number of types of registration-requested biometric information is two or more, the electronic device may authenticate biometric information, which is sensed first by the electronic device, from among a plurality of types of pieces of biometric information. According to an embodiment, if the biometric information is authenticated, the electronic device may generate a private key and a public key corresponding to the account information. According to an embodiment, the electronic device may sign the nonce using the generated private key. According to an embodiment, the electronic device may transmit the account information, the signed nonce, the ID of the biometric information corresponding to the account information, and the public key to the authentication server.

In operation 850, the electronic device may receive the response to the registration request from the authentication server. For example, the authentication server may verify the account information, the signed nonce, the ID of the biometric information corresponding to the account information, and the public key, which are received from the electronic device. The authentication server may verify the signed nonce by the public key. If the response to the registration request is received, the electronic device may perform authentication on the biometric information corresponding to the registered account information.

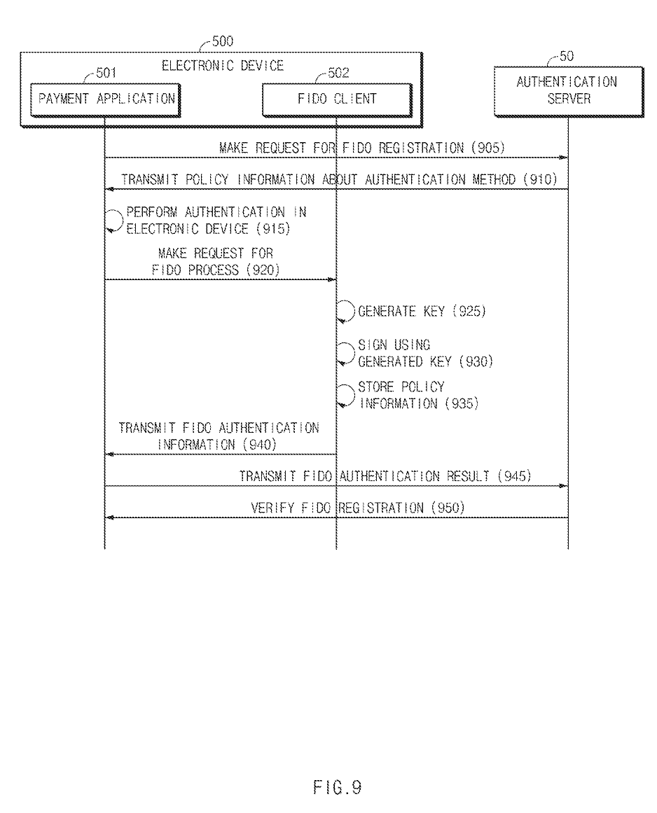

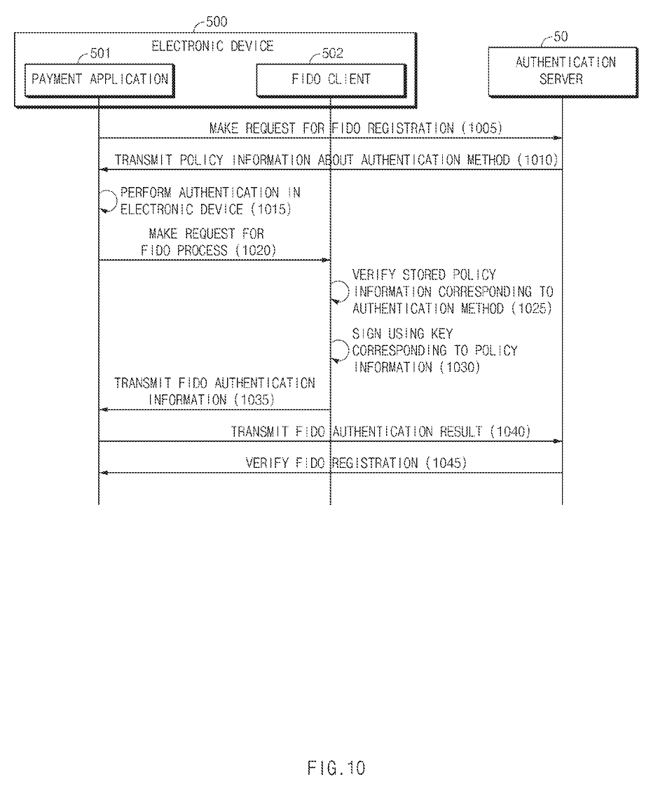

According to various embodiments, the electronic device may perform FIDO authentication on a plurality of biometric sensors (e.g., the first biometric sensor 510 and second biometric sensor 520) using one key pair (e.g., a private key and a public key). For example, when registering one of a plurality of biometric sensors, the electronic device may receive authentication policy information from a FIDO server. When generating a key, the electronic device may store the authentication policy information. In the case where the electronic device uses the biometric sensor registered later or the unregistered biometric sensor, the electronic device may determine whether information about the biometric sensor to be used is included in the stored authentication policy information. In the case where the corresponding biometric sensor is included in the authentication policy information, the electronic device may perform authentication using the key corresponding to the authentication policy information. The FIDO server may perform FIDO authentication by verifying the validity of the authentication policy information transmitted to the electronic device. The detailed registration operation and authentication operation will be described with reference to FIGS. 9 and 10.

FIG. 9 is a flowchart illustrating an example biometric information authenticating method of an electronic device, according to an example embodiment.

Hereinafter, it is assumed that the electronic device 500 of FIG. 5 performs a process of FIG. 9. In addition, as described in FIG. 9, it is understood that the operation described as being executed by the electronic device is controlled by the processor 550 of the electronic device 500. The processor 550 may execute an operation by executing a payment application 501 and a FIDO client 502.

According to an embodiment, the electronic device may perform authentication using one key pair. For example, the electronic device may generate one private key and one public key corresponding to a plurality of biometric sensors included in the electronic device and may perform authentication associated with a plurality of biometric sensors using one private key and one public key. Operations for generating one private key and one public key will be described with reference to FIG. 9. Operations for performing authentication using one private key and one public key will be described in greater detail below with reference to FIG. 10.

Referring to FIG. 9, in operation 905, the payment application may make a request for registration to an authentication server. For example, the payment application may make a request for the registration of one account information corresponding to a plurality of biometric sensors included in the electronic device.

In operation 910, the payment application may receive policy information about an authentication method from the authentication server. For example, the payment application may receive policy information including information about a plurality of biometric sensors included in the electronic device. For example, the policy information may include information about whether all the plurality of biometric sensors use the same key or whether each of the plurality of biometric sensors uses different key. The payment application may receive account information and nonce, which correspond to the plurality of biometric sensors, together with the policy information.

In operation 915, the payment application may perform authentication in the electronic device. For example, the payment application may obtain biometric information using one of the plurality of biometric sensors and may compare the obtained biometric information with the stored biometric information. In the case where the obtained biometric information is the same as the stored biometric information, the payment application may authenticate the biometric information.

In operation 920, the payment application may make a request for a FIDO process to the FIDO client. For example, the FIDO process may include an operation such as the generation of a key, the signature using the key, or the like.

In operation 925, the FIDO client may generate the key. For example, the FIDO client may generate a private key and a public key for the authentication of the biometric information obtained by the plurality of biometric sensors. The generated private key and public key may be matched with the policy information received from the authentication server.

In operation 930, the FIDO client may sign using the generated key. For example, the FIDO client may sign the nonce received from the authentication server using the generated private key.

In operation 935, the FIDO client may store the policy information. For example, the FIDO client may store the private key and the public key together with the policy information.

In operation 940, the FIDO client may transmit FIDO authentication information to the payment application. For example, the FIDO client may transmit the signed nonce and the public key to the payment application.

In operation 945, the payment application may transmit the authentication result to the authentication server. For example, the payment application may transmit the account information corresponding to the plurality of biometric sensors, the signed nonce, the ID of the biometric information, and the public key to the authentication server.

In operation 950, the payment application may receive the registration verifying result from the authentication server. For example, if the account information, the signed nonce, the ID of the biometric information, and the public key are verified, the authentication server may transmit the registration verifying result to the payment application. If the registration is verified, the payment application may perform authentication using the registered biometric sensor.

FIG. 10 is a flowchart illustrating an example biometric information authenticating method of an electronic device, according to an example embodiment.

Hereinafter, it is assumed that the electronic device 500 of FIG. 5 performs a process of FIG. 10. In addition, as described in FIG. 10, it is understood that the operation described as being executed by the electronic device is controlled by the processor 550 of the electronic device 500 The processor 550 may execute an operation by executing the payment application 501 and the FIDO client 502.

Referring to FIG. 10, in operation 1005, the payment application may make a request for authentication to an authentication server. For example, the payment application may make a request for the authentication of biometric information obtained by a plurality of biometric sensors included in the electronic device.

In operation 1010, the payment application may receive policy information about an authentication method from the authentication server. For example, the payment application may receive policy information the same as the policy information received in operation 910. The payment application may receive account information and nonce corresponding to a plurality of biometric sensors together with the policy information.

In operation 1015, the payment application may perform authentication in the electronic device. For example, the payment application may obtain biometric information using one of the plurality of biometric sensors and may compare the obtained biometric information with the stored biometric information. In the case where the obtained biometric information is the same as the stored biometric information, the payment application may authenticate the biometric information.

In operation 1020, the payment application may make a request for a FIDO process to the FIDO client. For example, the FIDO process may include an operation such as the signature using the key, or the like.

In operation 1025, the FIDO client may verify the stored policy information corresponding to the authentication method. For example, the FIDO client may verify policy information stored in operation 935. The FIDO client may verify policy information the same as the policy information received in operation 1010.

In operation 1030, the FIDO client may sign using the key corresponding to the policy information. For example, the FIDO client may sign the nonce received from the authentication server using a private key corresponding to the policy information received in operation 1010.

In operation 1035, the FIDO client may transmit FIDO authentication information to the payment application. For example, the FIDO client may transmit the signed nonce to the payment application.

In operation 1040, the payment application may transmit the authentication result to the authentication server. For example, the payment application may transmit account information corresponding to a plurality of biometric sensor, the signed nonce, and the ID of the biometric information to the authentication server.

In operation 1045, the payment application may receive the authentication verifying result from the authentication server. For example, the authentication server may verify the signed nonce using the public key transmitted in operation 945. If the authentication is verified, the payment application may make a payment.

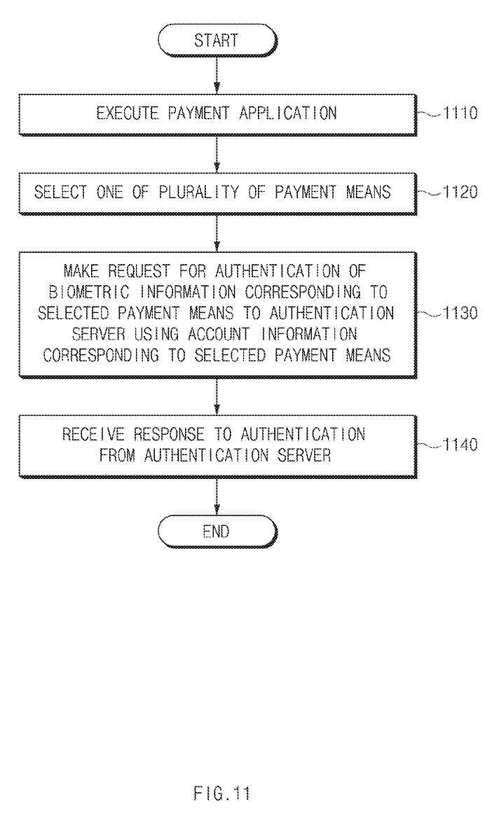

FIG. 11 is a flowchart illustrating an example biometric information authenticating method of an electronic device, according to an example embodiment.

Hereinafter, it is assumed that the electronic device 500 of FIG. 5 performs a process of FIG. 11. In addition, as described in FIG. 11, it is understood that the operation described as being executed by the electronic device is controlled by the processor 550 of the electronic device 500

According to an embodiment, the electronic device may perform authentication using biometric information corresponding to a payment means selected by a user. Since the type of the biometric information required depending on a payment means is different, the electronic device may determine the type of the biometric information to be authenticated based on the payment means.

Referring to FIG. 11, in operation 1110, the electronic device may execute a payment application. For example, the electronic device may execute or launch “Samsung Pay™” or the like being the payment application for making a payment.

In operation 1120, the electronic device may select one of a plurality of payment means. For example, when the payment application is executed, a GUI for selecting the payment means may be output to the electronic device. For example, the electronic device may select one of a plurality of credit cards registered in the electronic device depending on a user input.

In operation 1130, the electronic device may make a request for the authentication of biometric information to an authentication server using the account information corresponding to the selected payment means. The biometric information required depending on the payment means may be different. For example, in the case where a first credit card and a second credit card are stored in the electronic device, the authentication of fingerprint information may be required in the case of the first credit card, and the authentication of iris information may be required in the case of the second credit card. The payment means may make a request for authentication of two or more biometric information. For example, if the first credit card is selected, the electronic device may make a request for the authentication of the fingerprint information to the authentication server using the first account information corresponding to the fingerprint information.

According to an embodiment, in the case where there is no account information corresponding to the selected payment means, the electronic device may generate account information corresponding to the selected payment means and may make a request for authentication using the generated account information.

In operation 1140, the electronic device may receive the response to the authentication from the authentication server. For example, in the case where the biometric information corresponding to the selected payment means is authenticated, the electronic device may receive the response from the authentication server. If the response is received, the electronic device may make a payment using the selected payment means.

The term “module” used in this disclosure may refer, for example, to a unit including one or more combinations of hardware, software and firmware. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of a dedicated processor, a CPU, an application-specific IC (ASIC) chip, a field-programmable gate array (FPGA), and a programmable-logic device for performing some operations, which are known or will be developed.

At least a part of an apparatus (e.g., modules or functions thereof) or a method (e.g., operations) according to various embodiments may be, for example, implemented by instructions stored in a computer-readable storage media in the form of a program module. The instruction, when executed by a processor (e.g., the processor 120), may cause the one or more processors to perform a function corresponding to the instruction. The computer-readable storage media, for example, may be the memory 130.

A computer-readable recording medium may include a hard disk, a floppy disk, a magnetic media (e.g., a magnetic tape), an optical media (e.g., a compact disc read only memory (CD-ROM) and a digital versatile disc (DVD), a magneto-optical media (e.g., a floptical disk)), and hardware devices (e.g., a read only memory (ROM), a random access memory (RAM), or a flash memory). Also, a program instruction may include not only a mechanical code such as things generated by a compiler but also a high-level language code executable on a computer using an interpreter. The above hardware unit may be configured to operate via one or more software modules for performing an operation according to various embodiments, and vice versa.

A module or a program module according to various example embodiments may include at least one of the above elements, or a part of the above elements may be omitted, or additional other elements may be further included. Operations performed by a module, a program module, or other elements according to various embodiments may be executed sequentially, in parallel, repeatedly, or in a heuristic method. In addition, some operations may be executed in different sequences or may be omitted. Alternatively, other operations may be added.

According to various example embodiments disclosed in this disclosure, authentication may be performed using pieces of account information respectively corresponding to a plurality of biometric sensors included in an electronic device, thereby simplifying the authentication procedure of biometric information.

Besides, a variety of effects directly or indirectly understood through this disclosure may be provided.

While the present disclosure has been illustrated and described with reference to various example embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a plurality of biometric sensors configured to sense pieces of biometric information of different types, respectively;
a communication circuit configured to communicate with an authentication server;
a memory configured to store a payment application; and
a processor electrically connected with the plurality of biometric sensors, the communication circuit, and the memory,
wherein the processor is configured to:
generate pieces of account information respectively corresponding to the plurality of biometric sensors;
make a request for authentication of the biometric information corresponding to the account information to the authentication server using account information, corresponding to biometric information to be authenticated, from among the pieces of account information, if the payment application is executed; and
receive a response to the request for the authentication from the authentication server.

2. The electronic device of claim 1, wherein the processor is configured to:
transmit the account information to the authentication server upon requesting the authentication.

3. The electronic device of claim 1, wherein the processor is configured to:
determine whether the account information is registered in the authentication server, based on the response received from the authentication server.

4. The electronic device of claim 3, wherein the processor is configured to:
determine that the account information is registered in the authentication server if the account information is received from the authentication server.

5. The electronic device of claim 3, wherein the processor is configured to:
obtain the biometric information corresponding to the account information using a biometric sensor corresponding to the account information if the account information is registered in the authentication server;
authenticate the biometric information corresponding to the account information in the electronic device; and
transmit the authentication result of the electronic device to the authentication server.

6. The electronic device of claim 3, wherein the processor is configured to:
receive the account information and a nonce from the authentication server if the account information is registered in the authentication server;
authenticate the biometric information corresponding to the account information in the electronic device;
sign the nonce using a private key corresponding to the account information; and
transmit the account information, the signed nonce, and an identifier (ID) of the biometric information corresponding to the account information to the authentication server.

7. The electronic device of claim 3, wherein the processor is configured to:
make a request for registration of the account information to the authentication server if the account information is not registered in the authentication server;
obtain the biometric information corresponding to the account information using a biometric sensor corresponding to the account information in the electronic device;
authenticate the biometric information corresponding to the account information in the electronic device; and
transmit the authentication result of the electronic device to the authentication server.

8. The electronic device of claim 3, wherein the processor is configured to:
make a request for registration of the account information to the authentication server if the account information is not registered in the authentication server;
receive a response to the registration request and a nonce from the authentication server;
authenticate the biometric information corresponding to the account information in the electronic device;
generate a private key and a public key corresponding to the account information;
sign the nonce using the private key; and
transmit the account information, the signed nonce, an ID of the biometric information corresponding to the account information, and the public key to the authentication server.

9. The electronic device of claim 1, wherein the processor is configured to:
make a request for authentication of a type of biometric information, having a higher frequency of use, from among two or more pieces of biometric information sensed by two or more biometric sensors to the authentication server.

10. The electronic device of claim 1, wherein the processor is configured to:
make a request for authentication of biometric information, having a type selected by a user of the electronic device, from among two or more pieces of biometric information sensed by two or more biometric sensors to the authentication server.

11. The electronic device of claim 1, wherein the processor is configured to:
delete account information corresponding to changed biometric information, from among the pieces of account information if one of the pieces of biometric information stored in the memory is changed.

12. The electronic device of claim 1, wherein the account information includes an ID of an account, an ID of the electronic device, and an ID of a biometric sensor corresponding to the account information.

13. A biometric information authenticating method of an electronic device including a plurality of biometric sensors, the method comprising:
generating pieces of account information respectively corresponding to the plurality of biometric sensors;
making a request for authentication of the biometric information corresponding to the account information to the authentication server using account information corresponding to biometric information to be authenticated, from among the pieces of account information, if a payment application is executed; and
receiving a response to the request for the authentication from the authentication server.

14. The method of claim 13, wherein the making of the request for the authentication includes:
transmitting the account information to the authentication server.

15. The method of claim 13, further comprising:
determining whether the account information is registered in the authentication server, based on the response received from the authentication server.

16. The method of claim 15, further comprising:
receiving the account information and a nonce from the authentication server if the account information is registered in the authentication server;
authenticating the biometric information corresponding to the account information in the electronic device;
signing the nonce using a private key corresponding to the account information; and
transmitting the account information, the signed nonce, and an ID of the biometric information corresponding to the account information to the authentication server.

17. The method of claim 15, further comprising:
making a request for registration of the account information to the authentication server if the account information is not registered in the authentication server;
receiving a response to the registration request and a nonce from the authentication server;
authenticating the biometric information corresponding to the account information in the electronic device;
generating a private key and a public key corresponding to the account information;
signing the nonce using the private key; and
transmitting the account information, the signed nonce, an ID of the biometric information corresponding to the account information, and the public key to the authentication server.

18. The method of claim 13, wherein the making of the request for the authentication includes:
making a request for authentication of a type of biometric information, having a higher frequency of use, from among two or more of biometric information sensed by two or more of biometric sensors to the authentication server.

19. The method of claim 13, wherein the making of the request for the authentication includes:
making a request for authentication of biometric information, having a type selected by a user of the electronic device, from among two or more of biometric information sensed by two or more of biometric sensors to the authentication server.

20. A non-transitory computer-readable recording medium having recorded thereon at least one instruction which, when executed by at least one processor, causes an electronic device to:
generate pieces of account information respectively corresponding to a plurality of biometric sensors;
make a request for authentication of the biometric information corresponding to the account information to the authentication server using account information, corresponding to biometric information to be authenticated, from among the pieces of account information, if a payment application is executed; and
receive a response to the request for the authentication from the authentication server.
